(19) United States
(12) Patent Application Publication
(10) Pub. No.: US 2008/0038048 A1
(43) Pub. Date: Feb. 14, 2008

(54) TEMPORARY FENCING CLAMP

(76) Inventors: John Pingel, Scappose, OR (US); Donald F. Misho, Portland, OR (US); Kenneth A. Pingel, Hillsboro, OR (US)

Correspondence Address: PATENTTM.US, P. O. BOX 82788, PORTLAND, OR, 97282-0788, US

(21) Appl. No.: 11/762,657

(22) Filed: Jun. 13, 2007

Related U.S. Application Data
(60) Provisional application No. 60/804,651, filed on Jun. 14, 2006.

(51) Int. Cl. F16B 2/02

(52) U.S. Cl. 403/24

(57) ABSTRACT

A clamp for use in building fences using framed fence sections, wherein the clamp includes two clasp portions, one having an integral bolt retained therein and the other having an integral receiver into which the bolt is threaded for securing the clasp portions together for clamping two fence section portions together.

### BACKGROUND OF THE INVENTION

This invention relates to fence systems, particularly to temporary reusable fences and more particularly to clamps used to hold sections of fences together.

Work sites, such as building construction sites, are usually enclosed by a temporarily erected fence which is typically about six feet high. The purpose of the fence is to prevent unauthorized access to the work site and to provide safety and security. When work at the enclosed site is completed, the fence is removed and hauled away to be used again elsewhere. This type of security or safety fence may be described as temporary and reusable.

The components of such a fence include individual portable fence panels, typically sized to be relatively easily handled for set up, transportation and take down, and clamps for connecting adjacent portable panels together.

One type of portable fence panel is a rectangular wire mesh or chain link panel within a rigid rectangular edge frame. The edge frame is typically made of metal tubing of circular cross section, and includes a top horizontal portion, a bottom horizontal portion, and an upright edge frame portion at each end of the framed fence panel.

Between each pair of fence panels in a fence, at least one clamp is used to confine the upright edge frame portions in a plane, separated and parallel to each other. A clamp, having two separated opposing cuffs, typically mirror images of one another, is employed to hold the panels together, with one cuff placed on one side of the fence and the opposing cuff placed directly opposite the first cuff on the other side of the fence. Then, a bolt is passed through central holes defined in the cuffs from one side of the fence, and a nut is then attached at the opposite side of the fence to the back of the bolt. The bolt/nut are then tightened, to hold the fence portions together by tightening the clamp to securely engage the fence portions. The bolt passes through the clamp cuffs roughly midway between the edge frames that are to be confined.

Disadvantages of these fence systems include the following:

The clamps are relatively difficult to assemble, as this involves simultaneously positioning the two cuffs at the front and back side of the fence portions, holding the cuffs in position while passing the bolt therethrough, then threading the nut onto the bolt, and finally, tightening the nut/bolt with at least one wrench (and more typically two wrenches). It can be difficult for one person to accomplish this assembly, and time consuming.

The standard bolt and nut configuration used to secure the clamp portions is readily disassembled by thieves wanting to gain entry to the fenced area, using only a normal pair of pliers.

As noted above, A disassembled clamp includes two clamp cuffs and at least one bolt and at least one nut, giving in total at least four separate parts.

### SUMMARY OF THE INVENTION

In accordance with the invention, an improved fence system is provided that addresses the problems defined above.

Accordingly, it is an aspect of the present invention to provide an improved fence system that provides easier assembly.

It is a further aspect of the present invention to provide an improved fence system in which labor and parts costs are reduced by reducing the number of fence parts required to be held in stock, and in reducing the complexity of dealing with these parts during on-site fence assembly and disassembly.

It is yet a further aspect of the invention to provide a fence clamping system that is more secure against easy disassembly by thieves armed only with pliers.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is perspective view of a preferred embodiment of a clamp in accordance with the present invention;

FIG. 2 is a cross-section of the clamp of FIG. 1 taken along line 2-2 of FIG. 1; and

FIG. 3 is an illustrative diagram showing two fence sections assembled with the clamp of the present invention.

### DETAILED DESCRIPTION

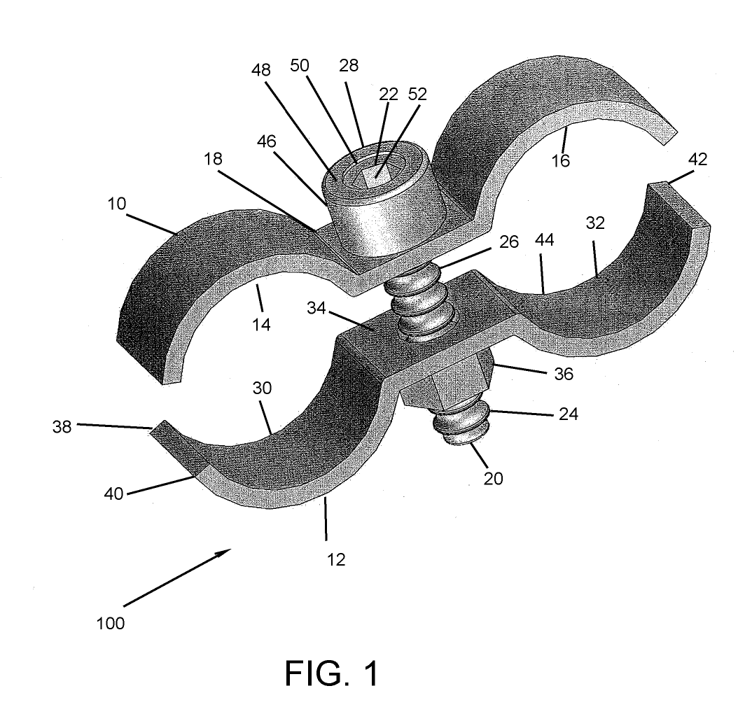

A clamp 100, according to a preferred embodiment of the present invention, is shown in perspective view in FIG. 1. A first clasp portion 10 is shown spaced apart from and opposed to a second clasp portion 12. In first clasp 10, a first arcuate gripper portion 14 and a second arcuate gripper portion 16 extend from a first central portion 18. A bolt 20 has a bolt head 22 and a threaded shaft 24. The shaft 24 extends through the first central portion 18 as indicated at location 26. The clasp 10 has an integral bolt retainer 28 for preventing the bolt 20 from being removed from or separated from the first clasp 10.

In the second clasp 12, a third arcuate gripper portion 30 and a forth arcuate gripper portion 32 extend from a second central portion 34. A nut 36 is permanently attached to the second central portion 34 of the second clasp 12 and is thus an integral portion of the second clasp 12. The shaft 24 of the bolt 20 is threaded into the threaded portion of the second clasp portion 12, that is to say, into the nut 36 in this embodiment.

With the first clasp portion 10 attached to the second clasp portion 12 by the bolt 20, the first gripper 14 and the second gripper 30 confine an upright portion of an edge frame (not shown in FIG. 1) of a first fence panel, and likewise second gripper 16 and fourth gripper 32 confine an upright portion of an edge frame (not shown in FIG. 1) of a second fence panel.

The various elements of clamp 100 may be made of any suitable materials, particularly metal or metal alloys, and any other suitable material, such as plastic, fiberglass, or the like.

With regard to the dimensions of the clamp 10, the height from point 38 to point 40 can be about one to two inches and if needed can be a twelve inches or more to more securely confine edge frames. The width of the clamp 100 from point 38 to point 42 can be about five inches, or considerably more or considerably less as required for a particular application.

With regard to the radius curvature of the grippers 14, 16, 30, and 32, the radius 44 of curvature is chosen in relation to the corresponding edge frame radial dimension, a radius of 0.75 inches being useful. However this radius of curvature may be varied over a wide range as required by specific applications.

Further, with regard to the opposing pair of grippers 14, and 30, for example, only one of these might be required to be curved to effect confinement of the first edge frame. Likewise, for grippers 16 and 32, again only one of these grippers might be curved to effect confinement of the second edge frame.

With regard to the bolt retainer 18, in FIG. 1, the bolt retainer 18, includes a cylindrical portion 46 laterally enclosing the bolt head 22 and cap portion 48 having a keyhole 50. Keyhole 50 gives access to socket 52 in bolt head. Socket 52 may have a unique configuration requiring a matching key and thus diminishing the possibility of unauthorized opening of the clamp 10, or, in a preferred embodiment, may comprise a hex configuration to receive and be driven to tighten or loosen the bolt by use of a hex driving tool, for example. Socket 52 which may comprise a hex configuration, having an Allen head configuration (flat sides) or a star head configuration (TORX brand, for example). Other configurations such as square drive sockets, 12-point drive, “+” style or flat head screwdriver types may also be employed for the configuration of socket 52.

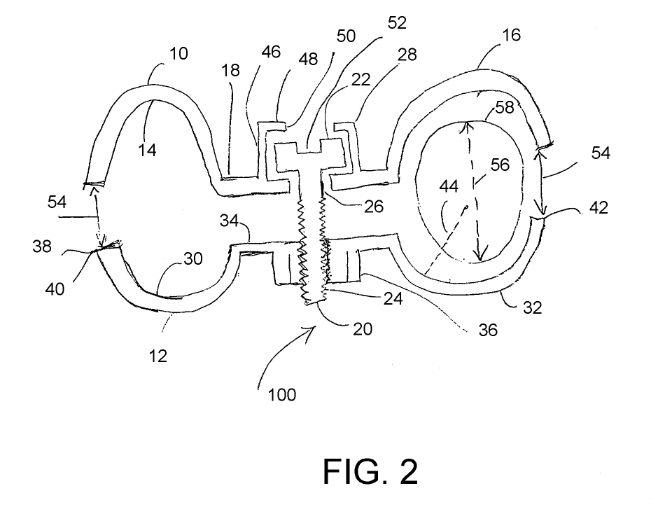

FIG. 2 is a cross section of the embodiment of the present invention shown in FIG. 1, the cross-section being taken along line 2-2 through the main axis of the bolt 22 and parallel to the line from point 38 to the point 42. FIG. 2 further includes a cross section of an edge frame of a fence panel for illustration of the engagement thereof.

It should be noted that the distance 54 between grippers 14 and 30 and between grippers 16 and 32 decreases as the bolt 20 is turned to close the clamp 10. The distance 54, when the clamp is closed, should not be greater than, and needs only to be a little less than the diameter 56 of the enclosed edge frame 58 of a fence section.

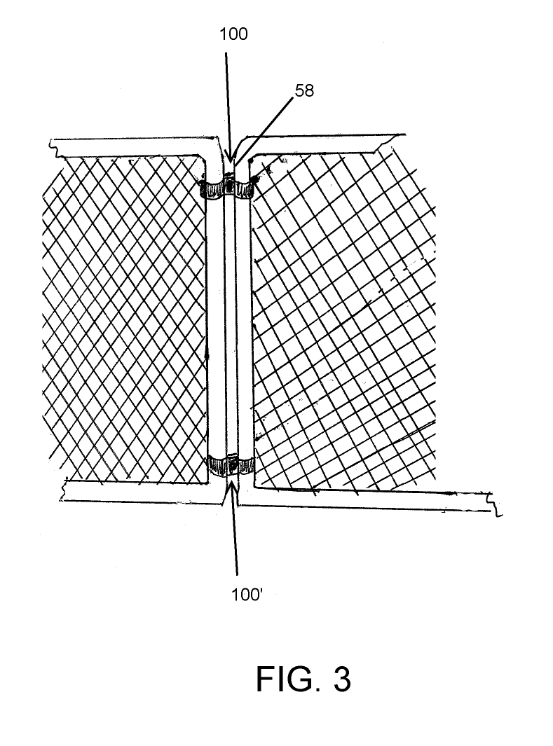

FIG. 3 illustrates a portion of 2 fence panels, showing the clamp 100 mounted at upper and lower (clamp 100′) portions thereof. The fence panels are suitable “chain link” type fence panels in a typical use, but this is not a requirement.

Accordingly, and improved clamp system for temporary fence portions is provided. The clamp is easily assembled, given that the bolt/nut combination portions (or other suitable engaging devices) are secured to their respective clamp portions, so that an assembly worker need only manage 2 clamp pieces, as contrasted to the prior art 4 piece clamp systems. The use of a hex drive or other type drive rather than the standard bolt head and corresponding nut allows that once assembled, the clamp is not so easily disassembled by a thief wanting entry to the fenced area via use of a simple pair of pliers.

Assembly (and disassembly) may suitably be accomplished by use of a portable electric drill or driver tool, with a hex head driver or other appropriate driver, for example.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A clamp for mechanically confining a first edge frame of a first fence section and a second edge frame of a second fence section, with the first edge frame being spaced apart from and approximately parallel to the second edge frame, the clamp comprising:
a first clasp part, comprising:
a first gripper portion for contacting the first edge frame;
a second gripper portion for contacting the second edge frame;
a first central portion located between the first gripper portion and the second gripper portion;
a bolt extending through the first central portion, the bolt having a bolt head a threaded body, the bolt head having socket for use in turning the bolt; and,
a bolt head retainer for preventing removal of the bolt, and
wherein at least one of the first gripper portion and the second gripper portion is curved in shape to partially enclose at least one of the first edge frame and the second edge frame;
a second clasp part, comprising:
a third gripper portion for contacting the first edge frame;
a fourth gripper portion for contacting the second edge frame;
a second central portion located between the third gripper portion and the fourth gripper portion; and,
in the second central portion, a threaded bolt receiver for receiving the bolt, and
wherein at least one of the third gripper portion and the fourth gripper portion is curved in shape to partially enclose at least one of the first edge frame and the second edge frame; and
wherein the socket is for receiving a key to rotate the bolt to join the first clamp part to the second clamp part, so that the first gripper part and the third gripper part confine the first edge frame and the second gripper part and the fourth gripper part confine the second edge frame.

2. The clamp according to claim 1, wherein at least portions of the first or second clasp parts comprise metal.

3. The clamp according to claim 2, wherein said metal comprises a metal alloy.

4. The clamp according to claim 1, wherein at least portions of the first or second clasp parts comprise plastic.

5. The clamp according to claim 1, wherein at least portions of the first or second clasp parts comprise fiberglass.

6. A method of joining a first and a second temporary fence section to one another, comprising:
providing a first and a second clasp member adapted for attachment to said first and second temporary fence section, said first and second clasp members comprising first and second complementary engagement members as integral portions thereof;
positioning said first and second clasp members at attachment positions on said temporary fence sections; and
engaging said first and second complementary engagement members to join said first and second temporary fence sections to one another.

7. The method according to claim 6, wherein said first and second complementary engagement members comprise a threaded engagement member and corresponding threaded receiving member.

8. The method according to claim 7, wherein said threaded engaging member includes a drive head for operation thereof.

9. The method according to claim 8, wherein said drive head comprises a hex configuration.

10. The method according to claim 8, wherein said drive head comprises a star head configuration.

11. A clamp for mechanically engaging a first fence section and a second fence section, comprising:
a first clasp for engaging a portion of the first fence section and a portion of the second fence section at first faces thereof;
a second clasp for engaging a portion of the first fence section and a portion of the second fence section at second faces thereof;
wherein said first and second clasp portions comprise a securing device formed integrally therewith for securing the relative positions of said first and second clasp portions relative to one another

12. The clamp according to claim 11, wherein said securing device comprises a threaded female portion formed as a portion of one of said first and second clasps and a threaded male portion formed as a portion of the other of said first and second clasps, said female and male portions of corresponding thread so as to be threadingly engagable.

13. The clamp according to claim 12, wherein said threaded male portion further comprises a socket portion for receiving a driving member therein for tightening and untightening operation thereof when engaging and disengaging with said threaded female portion.

14. The clamp according to claim 13, wherein said socket portion comprises a hex configuration.

15. The clamp according to claim 13, wherein said socket portion comprises a star configuration.

16. The clamp according to claim 11, wherein at least portions of the first or second clasps comprise metal.

17. The clamp according to claim 16, wherein said metal comprises a metal alloy.

18. The clamp according to claim 11, wherein at least portions of the first or second clasps comprise plastic.

19. The clamp according to claim 11, wherein at least portions of the first or second clasps comprise fiberglass.
